(19) United States
(12) Patent Application Publication
(10) Pub. No.: US 2026/0362101 A1
(43) Pub. Date: Nov. 12, 2026

(54) Co-Syne

(71) Applicant: Byron A. Jackson, Opelika, AL (US)

(72) Inventor: Byron A. Jackson, Opelika, AL (US)

(21) Appl. No.: 16/279,934

(22) Filed: Feb. 19, 2019

(51) Int. Cl. H04W 4/46; H04W 64/00; H04W 84/06

(52) U.S. Cl. CPC H04W 4/46; H04W 64/006; H04W 84/06

(57) ABSTRACT

A vehicle communication system is disclosed, enabling direct wireless communication between law enforcement vehicles and civilian vehicles through infotainment displays. The system comprises a host vehicle two-way communication device, a vehicle positioning component, a vehicle mapping component, and a broadcasting power modulating component. The system utilizes Bluetooth and Dedicated Short-Range Communications (DSRC) to transmit dynamic vehicle attributes, such as GPS location and speed, between vehicles. The invention facilitates secure and efficient communication within a defined broadcast area, enhancing vehicle safety and law enforcement interactions while integrating seamlessly with existing infotainment systems.

### SUMMARY OF THE INVENTION

The invention generally relates to a vehicle communication system for direct communication between law enforcement vehicles and citizen vehicles. Various informational systems will be able to interact with the wireless communication between vehicles such as roadside units and other safety vehicles. These wireless communication infotainment systems have a range of applications from crash avoidance to entertainment which makes them able to be placed in many vehicles. Enabling these communication systems might be possible with varying costs and capabilities. Some examples of wireless technology systems that are currently available include Bluetooth systems, wireless LAN systems and dedicated short range communications (DSRC) systems.

Dedicated short range communications (DSRC) is a developing technology that has been recently explored for aptness in vehicles for a wide range of applications. This short range technology will permit vehicles to connect directly with other vehicles and with roadside units to exchange a wide array of information through communication. Another significant feature of DSRC technology is the ability to conduct both point-to-point wireless communications and broadcast wireless messages in a restricted broadcast area. The broadcast area being around and between the law enforcement vehicle and the stopped vehicle. Therefore, DSRC technology can be used to provide various info between vehicles and to/from infrastructure, and from vehicle-to-vehicle, such as providing GPS location, vehicle speed and other vehicle Parameter Identifiers (PIDs). This data would be communicated between the users to provide the users with a complete understanding of the vehicles in the broadcast area and their performance. This information then can be used by the vehicles for vehicle safety applications and for short-range communication.

### BACKGROUND OF THE INVENTION

Vehicle to vehicle communications are only moderately considered. Little opportunity exists for entertaining and/or helpful communications between vehicles. A need therefore exists for a way to better facilitate vehicle to vehicle communications. If possible, communications should generally remain relevant and pertinent to either the vehicle and/or occupants thereof. Distracting and irrelevant information should preferably be minimized. Also, with digital short range communications likely to be adopted for use in a considerable number of vehicles, a solution that is at least compatible with such communications and which preferably influences the existence of such communications capability would aid in ensuring a cost-efficient and more widely available solution.

In actual, vehicles and/or vehicle occupants can readily and capably locate and communicate with other vehicles and/or occupants that establish what may be viewed as a virtual fleet. Based upon this capability a way for wirelessly communicating includes receiving, from a transceiver, a message associated with a value for a dynamic attribute of a vehicle. The message related with the value for the dynamic attribute is wirelessly transmitted by a converter to an infotainment display system. The converter is connected to the transceiver and an on-board vehicle processor.

The preceding object can essentially be attained by providing a vehicle communication system that includes a host vehicle two-way communication device. The vehicle positioning component configured to determine a host vehicle position of the host vehicle. The host vehicle two-way communication device is configured to conduct short range communications in a host vehicle broadcast area around a host vehicle equipped with the vehicle communication system.

### DESCRIPTION

Many two-way radios include an internal processor that can readily serve as the processor of this system. Therefore, if chosen, and as suitable to a particular application, the processor and the digital short range radio can be comprised of an internal unit. The vehicle must include an antenna, a transceiver, and on-board vehicle processor connected through a converter, and status modules. The system includes a processor that comprises a computational platform with adequate computational ability and features to support the various capabilities and activities. Many such computational platforms exist and selecting a specific platform involves a variety of considerations concerning the certain setting and application that are not relevant here.

A two-way communication system operably pairs to the processor such that the processor can control the transmission payloads and activity of the infotainment system and can receive the message content of messages as received by the system. The user interface can include both input and output capability as fitting to the application. For example, the user interface can include output devices such as a visual display and/or an audio transducer to extract message content as received through the digital short range radio obvious to an occupant of the vehicle.

So constituted, the processor can optionally obtain information about a present location of the vehicle from the location unit, information regarding various vehicular metrics including present speed and heading from the vehicular sensors, and information regarding a presently selected entertainment selection in the vehicle from the entertainment unit. Based upon this capability, many benefits are realized including the ability to attract and locate information and communications of relevance to the user and their vehicle/other vehicles. The system provides a unique vehicle identifier. Such a unique vehicle identifier can be, for example, the vehicle identification number, a unique identifier as administered by some other processor or service, a vehicular license in combination with a state of issue identifier, a combination of these approaches, or any other identifier that will serve to distinctively identify the vehicle. This vehicular identifier allows subsequent messages to be received and processed by the system in the vehicle and further aids to mark and identify transmitted messages as may be suitable to facilitate the capabilities.

Wireless communication systems have become a part of everyday life. Modern vehicles have embraced this movement by integrating onboard wireless communication systems—both systems which are fully implanted in the vehicle, and vehicle-based systems which can connect with other vehicles systems. The systems will take this wireless communication and implement them into the vehicles infotainment systems to communicate between other vehicles using Bluetooth internet. The information will be taken from the citizen vehicle by the law enforcement vehicle and recorded back at the department server.

Many devices, which can be linked to a vehicle's information and entertainment (infotainment) system, support data download from several internet sources if a suitable network connection is accessible.

### BRIEF DESCRIPTION OF THE DRAWINGS

FIG. 1 is a diagram showing how information will be transmitted from vehicle to vehicle (100). The law enforcement car (100) transmits (101) information to the other vehicles on-board receiver (102) and processor using the tower (104). The satellite (103) tracks and records the vehicles GPS location while recording the information transmitted to a database.

FIG. 2 is an overhead view showing the short-range communication distance around the law enforcement vehicle (201) and the other vehicle (202). The gray area around the vehicles signifies the short range wireless capabilities of vehicle to vehicle communication.

FIG. 3 Radio frequency transmits an analog signal to a modulator-demodulator unit which converts the signal to a digital signal. The converter encodes the signal to Bluetooth and/or wifi protocol which it then broadcasts through the infotainment system.

FIG. 4 is a written diagram explaining the process of the vehicle to vehicle communication from getting pulled over by a law enforcement vehicle.

FIG. 5 is a written diagram explaining the process of information being sent and being received by the towers and satellites.

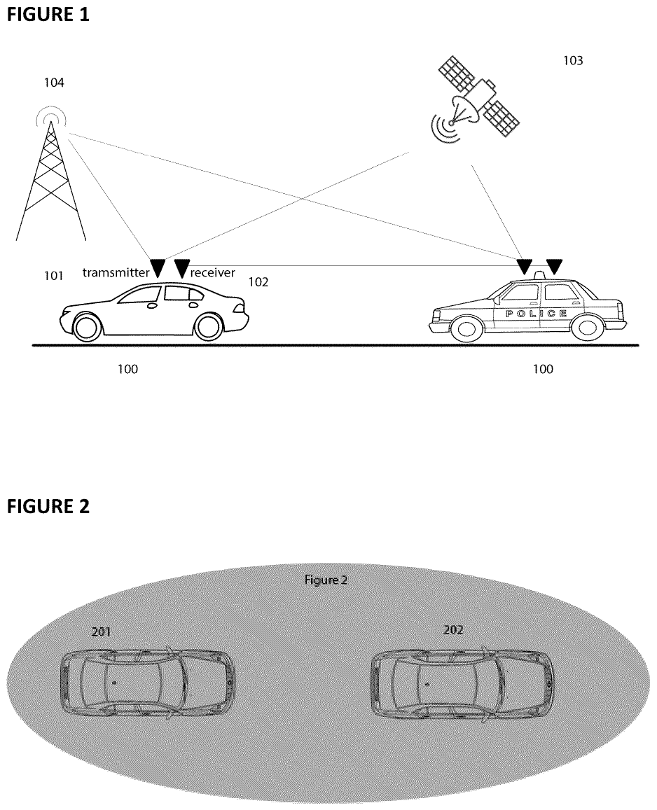

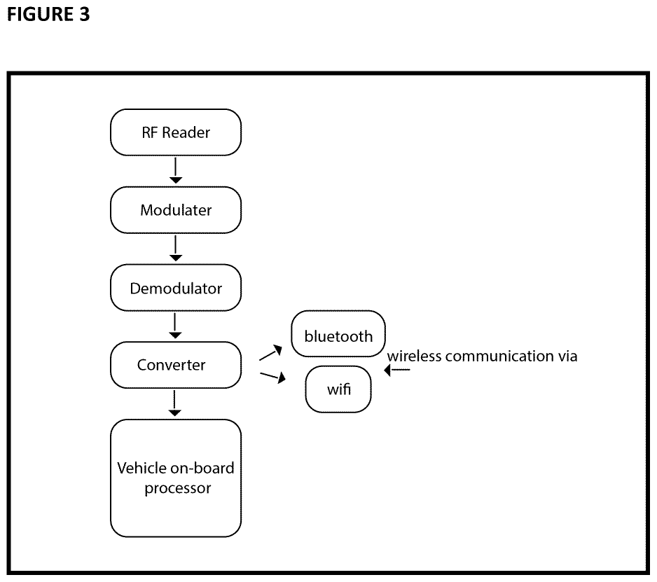

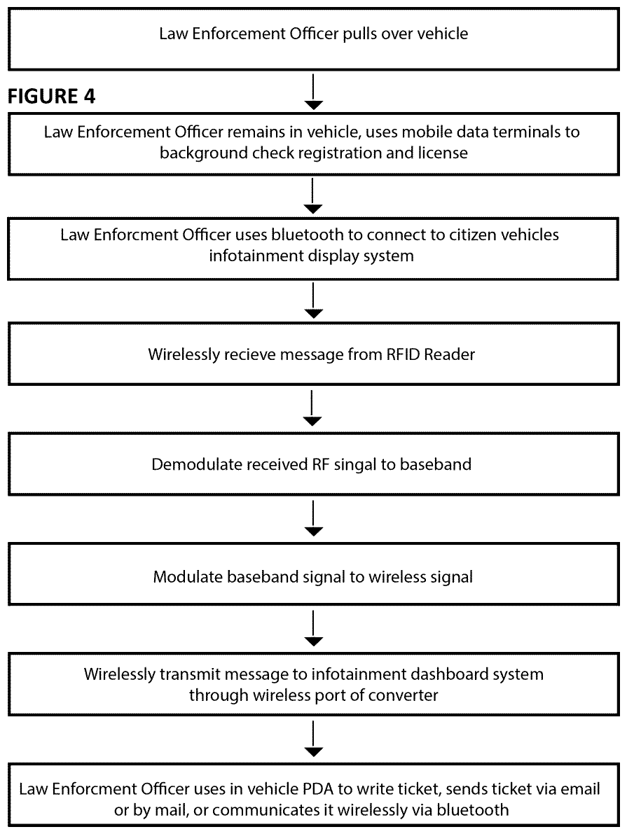

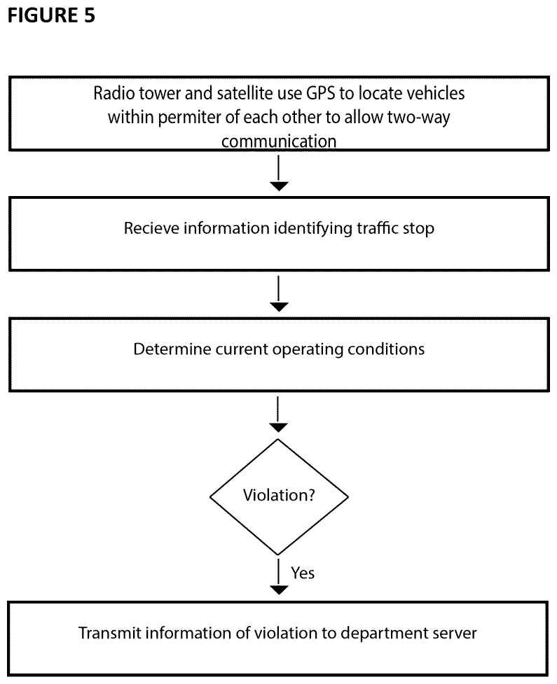

1. An on-board vehicle-to-vehicle communication system comprising:
a. A GPS device configured to communicate with a satellite and acquire real-time position information;
b. A transceiver configured to transmit and receive wireless signals using Dedicated Short-Range Communications (DSRC) and Bluetooth protocols;
c. An infotainment display system configured to present received messages to vehicle occupants;
d. A processor operably connected to the GPS device, transceiver, and infotainment display system, wherein the processor is configured to:
i. Form a secure wireless network between a law enforcement vehicle and a civilian vehicle;
ii. Transmit dynamic vehicle attributes, including GPS location and speed, to the law enforcement vehicle; and
iii. Display received messages on the infotainment display system.

2. An infotainment display system comprising:
a. A display device configured to present received messages to vehicle occupants;
b. A data transmission interface accessible to a user, enabling interaction with the infotainment system.

3. A data processing method comprising:
a. Receiving, by a device in the vehicle, data from an external processor;
b. A first processor configured to execute a web application; and
c. A second processor configured to output vehicle data to the first processor.
